(19) United States
(12) Patent Application Publication
(10) Pub. No.: US 2005/0001333 A1
(43) Pub. Date: Jan. 6, 2005

(54) Method for producing, via organometallic compounds, organic intermediate products

(76) Inventors: Detlef Wehle, Brechen (DE); Klaus Forstinger, Babenhausen (DE); Andreas Meudt, Floersheim-Weilbach (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 10/491,967

(22) PCT Filed: Oct. 2, 2002
(86) PCT No.: PCT/EP02/11052

(30) Foreign Application Priority Data
Oct. 12, 2001 (DE) 101 50 614.7

(51) Int. Cl. C07F 1/02

(52) U.S. Cl. 260/665 R; 546/1

(57) ABSTRACT

The present invention provides a process for preparing aryllithium compounds by reacting haloaliphatics with lithium metal to form a lithium alkyl and reacting the lithium alkyl with aromatic halogen compounds of formula (III) in a halogen-metal exchange reaction to form the corresponding lithium aromatics of formula (IV).

The invention relates to a process for preparing organic compounds by producing aryllithium compounds and reacting them with suitable electrophiles, in which haloaliphatics are firstly reacted with lithium metal to generate a lithium alkyl (step 1 in equation 1) which is subsequently reacted in a halogen-metal exchange reaction with aromatic halogen compounds to form the desired lithium aromatics (step 2 in equation I), and these are subsequently reacted with an appropriate electrophile,

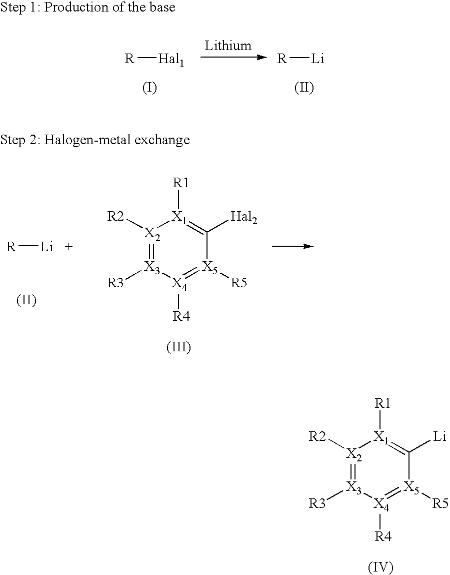

(Equation I)

The upswing in organometallic chemistry, particularly that of the element lithium, in the preparation of compounds for the pharmaceutical and agrochemical industries and also for numerous further applications has proceeded almost exponentially in recent years if the number of applications or the amount of products produced in this way is plotted against a time axis. Reasons for this are essentially the ever more complex structures of the fine chemicals required for the pharmaceuticals and agrochemicals sectors and also the virtually unlimited synthesis potential of organolithium compounds for the buildup of complex organic structures.

Virtually any organolithium compound can be easily produced by means of the modern arsenal of organometallic chemistry and can be reacted with virtually any electrophile to form the desired product. Most organolithium compounds are generated in one of the following ways:

(1) The most important route without doubt is halogen-metal exchange in which usually bromoaromatics are reacted with n-butyllithium at low temperatures.

(2) Very many organometallic Li compounds can likewise be prepared by reacting bromoaromatics with lithium metal.

(3) Also very important is the deprotonation of sufficiently acidic organic compounds with lithium alkyls (e.g. BuLi), lithium amides (e.g. LDA or LiNSi) or the Schlosser superbases (RLi/KOtBu).

It follows from this that the use of commercially available alkyllithium compounds is required for the major part of this chemistry, with n-BuLi usually being used here. The synthesis of n-BuLi and related lithium aliphatics is technically complicated and requires a great deal of know-how, so that n-butyllithium, s-butyllithium, tert-butyllithium and similar molecules are available only at very high prices, judged by industrial standards. This is the most important but by far not the only disadvantage of this otherwise very advantageous and widely usable reagent.

Owing to the extreme sensitivity and, in concentrated solutions, pyrophoric nature of such lithium aliphatics, very elaborate logistic systems for transport, introduction into the metering stock vessel and metering have to be built up, requiring a high capital investment in plant, for the quantities wanted in industrial production (annual production quantities of from 5 to 500 metric tons).

Furthermore, the reactions of n-, s- and tert-butyllithium form either butanes (deprotonations), butyl halides (halogen-metal exchange, 1 equivalent of BuLi) or butene and butane (halogen-metal exchange, 2 equivalents of BuLi) which are gaseous at room temperature and are given off in the hydrolytic work-ups of the reaction mixtures which are required. This results in an additional requirement for complicated offgas purification facilities or appropriate incineration facilities in order to meet strict legal pollution regulations. As a way around this problem, specialist companies offer alternatives such as n-hexyllithium, but although these do not result in formation of butanes, they are significantly more expensive than butyllithium.

A further disadvantage is the formation of complex solvent mixtures after the work-up. Owing to the high reactivity of alkyllithium compounds toward ethers which are virtually always solvents for the subsequent reactions, alkyllithium compounds can usually not be marketed in these solvents. Although the manufacturers offer a broad range of alkyllithium compounds of a wide variety of concentrations in a wide variety of hydrocarbons, halogen-metal exchange reactions, for example, do not proceed in pure hydrocarbons, so that one is forced to work in mixtures of ethers and hydrocarbons. As a result, water-containing mixtures of ethers and hydrocarbons are obtained after hydrolysis, and the separation of these is complicated and in many cases cannot be carried out economically at all. However, recycling of the solvents used is an absolute requirement for large-scale industrial production.

For the reasons mentioned, it would be very desirable to have a process in which the alkyllithium compound to be used is produced from the cheap raw materials haloalkane and lithium metal in an ether and is simultaneously or subsequently reacted with the haloaromatic to be reacted, since this procedure would enable all the abovementioned disadvantages of the “classical” production of lithium aromatics to be circumvented.

The present invention achieves all these objects and provides a process for preparing aryllithium compounds by reacting haloaliphatics with lithium metal to form a lithium alkyl and reacting this further with aromatic halogen compounds (III) in a halogen-metal exchange reaction to form the corresponding lithium aromatics (IV), and, if desired, reacting these with an appropriate electrophile in a further step (equation I).

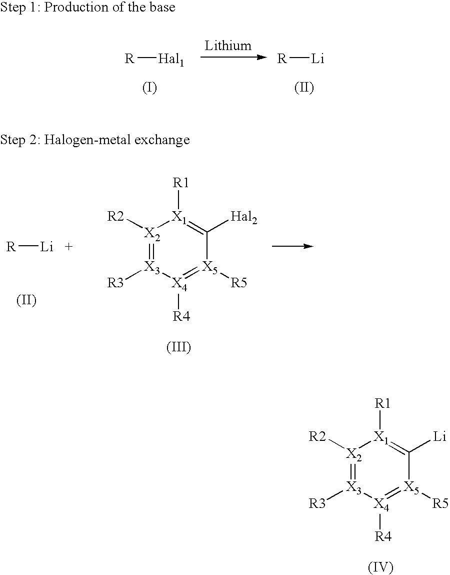

(Equation I)

where R is methyl, a primary, secondary or tertiary alkyl radical having from 2 to 12 carbon atoms, which may be substituted by a radical from the following group: {phenyl, substituted phenyl, aryl, heteroaryl, alkoxy, dialkylamino, alkylthio}, substituted alkyl, substituted or unsubstituted cycloalkyl having from 3 to 8 carbon atoms,

Hal₁=fluorine, chlorine, bromine or iodine,

Hal₂=chlorine, bromine or iodine,

X₁₋₅ are, independently of one another, each carbon or one or more moieties

X₁₋₅R₁₋₅ can be nitrogen or two adjacent radicals X₁₋₅R₁₋₅ can together be O (furans), S (thiophenes), NH or NR′ (pyrroles), where R′ is C₁-C₅-alkyl, SO₂-phenyl, SO₂-p-tolyl or benzoyl.

Preferred compounds of the formula (III) which can be reacted by the process of the invention are, for example, benzenes, pyridines, pyrimidines, pyrazines, pyridazines, furans, thiophenes, pyrroles, pyrroles which are N-substituted in any desired way or napthalenes. Suitable compounds of this type are, for example, bromobenzene, 2-, 3- and 4-bromobenzotrifluoride, 2-, 3- and 4-chlorobenzotrifluoride, furan, 2-methylfuran, furfural acetals, thiophene, 2-methylthiophene, N-trimethylsilylpyrrole, 2,4-dichlorobromobenzene, pentachlorobromobenzene and 4-bromobenzonitrile or 4-iodobenzonitrile.

The radicals R₁₋₅ are substituents selected from the group consisting of {hydrogen, methyl, primary, secondary or tertiary, cyclic or acyclic alkyl radicals having from 2 to 12 carbon atoms, in which one or more hydrogen atoms may be replaced by fluorine, e.g. CF₃, substituted cyclic or acyclic alkyl groups, alkoxy, dialkylamino, alkylamino, arylamino, diarylamino, phenyl, substituted phenyl, alkylthio, diarylphosphino, dialkylphosphino, dialkylaminocarbonyl or diarylaminocarbonyl, monoalkylaminocarbonyl or monoarylaminocarbonyl, CO₂⁻, hydroxyalkyl, alkoxyalkyl, fluorine and chlorine}, or two adjacent radicals R₁₄ can together correspond to an aromatic or aliphatic fused-on ring.

The organolithium compounds prepared in this way can be reacted with any electrophilic compounds by methods of the prior art. For example, C,C couplings can be carried out by reaction with carbon electrophiles, boronic acids can be prepared by reaction with boron compounds, and a very efficient route to organosilanes is opened up by reaction with halosilanes or alkoxysilanes.

As haloaliphatics (I), it is possible to use all available or preparable fluoroaliphatics, chloroaliphatics, bromoaliphatics or iodoaliphatics, since lithium metal reacts easily and in virtually all cases in quantitative yields with all haloaliphatics in ether solvents. Preference is given to using chloroaliphatics or bromoaliphatics, since iodine compounds are often expensive and fluorine compounds lead to the formation of LiF which in later aqueous work-ups can form HF and lead to materials problems. However, such halides can also be used advantageously in specific cases.

Alkyl halides which are converted by halogen-metal exchange into liquid alkanes/alkenes (two equivalents of RLi) or alkyl halides (one equivalent of RLi) are preferably used. Particular preference is given to using chlorocyclohexane or bromocyclohexane, benzyl chloride, chlorohexanes or chloroheptanes.

Suitable ether solvents are, for example, tetrahydrofuran, dioxane, diethyl ether, di-n-butyl ether, diisopropyl ether or anisole. Preference is given to using THF.

Owing to the high reactivity of alkyllithium and aryllithium compounds, in particular toward, inter alia, the ethers used as solvents, the preferred reaction temperatures are in the range from −100 to +25° C., particularly preferably from −80 to −10° C.

In most cases, it is possible to work at quite high concentrations of organolithium compounds. Preference is given to concentrations of the aliphatic or aromatic intermediates (IV) of from 5 to 30% by weight, in particular from 12 to 25% by weight.

In the two preferred embodiments, the haloalkane is firstly added to the lithium metal in the ether, with the lithium aliphatic (II) firstly being formed. Subsequently, either the haloaromatic (III) to be methylated is added first and the electrophilic reactant is added subsequently or, in a one-pot variant, haloaromatic and electrophile are added either as a mixture or simultaneously.

It has surprisingly been found that in the preferred embodiment as a one-pot reaction, higher yields are observed in many cases compared to when RLi is generated first and is then reacted firstly with haloaromatic and only afterwards with the electrophile.

In the present process, the lithium can be used as dispersion, powder, turnings, sand, granules, lumps, bars or in another form, with the size of the lithium particles not being relevant to quality but merely influencing the reaction times. For this reason, relatively small particle sizes are preferred, for example granules, powders or dispersions. The amount of lithium added per mole of halogen to be reacted is from 1.95 to 2.5 mol, preferably from 1.98 to 2.15 mol.

In all cases, significant increases in the reaction rate can be observed at the stage of preparing RLi by adding organic redox systems, for example biphenyl, 4,4-di-tert-butylbiphenyl or anthracene. The addition of such systems has been found to be advantageous especially when the lithiation times are >12 hours without this catalysis. The concentrations of the organic catalyst added are advantageously from 0.01 to 1 mol %, preferably 0.05 to 0.1 mol %.

Aromatics which can be used for the halogen-metal exchange are, firstly, all aromatic bromine and iodine compounds. In the case of chlorine compounds, those having activating, i.e. strongly electron-withdrawing, substituents such as CF₃ radicals can be lithiated in good yields.

The lithium aromatics (IV) generated according to the invention can be reacted with electrophilic compounds by the methods with which those skilled in the art are familiar, with carbon, boron and silicon electrophiles being of particular interest with a view to the intermediates required for the pharmaceutical and agrochemical industries.

The reaction with the electrophile can either be carried out after production of the lithiated compound (III) or, as described above, in a one-pot process by simultaneous addition to the reaction mixture.

The carbon electrophiles come, in particular, from one of the following categories (the products are in each case indicated in brackets):
aryl or alkyl cyanates (benzonitriles)
oxirane, substituted oxiranes (ArCH₂CH₂OH, ArCR₂CR₂OH) where R═R¹ (identical or different)
azomethines (ArCR¹₂—NR′H)
nitroenolates (oximes)
immonium salts (aromatic amines)
haloaromatic, aryl triflates, other arylsulfonates (biaryls)
carbon dioxide (ArCOOH)
carbon monoxide (Ar—CO—CO—Ar)
aldehydes, ketones (ArCHR¹—OH, ArCR¹₂—OH)
α,β-unsaturated aldehydes/ketones (ArCH(OH)-vinyl, CR¹(OH)-vinyl)
ketenes (ArC(═O)CH₃ in the case of ketene, ArC(═O)—R¹ in the case of substituted ketenes)
alkali metal and alkaline earth metal salts of carboxylic acids (ArCHO in the case of formates, ArCOCH₃ in the case of acetates, ArR¹CO in the case of R¹COOMet)
aliphatic nitriles (ArCOCH₃ in the case of acetonitrile, ArR¹CO in the case of R¹CN)
aromatic nitriles (ArCOAr′)
amides (ArCHO in the case of HCONR₂, ArC(═O)R in the case of RCONR′₂)
esters (Ar₂C(OH)R¹) or
alkylating agents (Ar-alkyl).

As boron electrophiles, use is made of compounds of the formula BW₃, where the radicals W are, independently of one another, identical or different and are each C₁-C₆-alkoxy, fluorine, chlorine, bromine, iodine, N(C₁-C₆-alkyl)₂ or S(C₁-C₅-alkyl), preferably trialkoxyboranes, BF₃*OR₂, BF₃*THF, BCl₃ or BBr₃, particularly preferably trialkoxyboranes.

As silicon electrophiles, use is made of compounds of the formula SiW₄, where the radicals W are, independently of one another, identical or different and are each C₁-C₆-alkoxy, fluorine, chlorine, bromine, iodine, N(C₁-C₆-alkyl)₂ or S(C₁-C₅-alkyl), preferably tetraalkoxysilanes, tetra-chlorosilanes or substituted alkylhalosilanes or arylhalosilanes or substituted alkylalkoxysilanes or arylalkoxysilanes.

The process of the invention opens up a very economical method of bringing about the transformation of aromatic halogen into any radicals in a very economical way.

The work-ups are generally carried out in an aqueous medium, with either water or aqueous mineral acids being added or the reaction mixture being introduced into water or aqueous mineral acids. To achieve the best yields, the pH of the product to be isolated is set here, i.e. usually a slightly acidic pH and in the case of heterocycles also a slightly alkaline pH. The reaction products are, for example, isolated by extraction and evaporation of the organic phases; as an alternative, the solvents can also be distilled from the hydrolysis mixture and the product which then precipitates can be isolated by filtration.

The purities of the products from the process of the invention are generally high, but for special applications (pharmaceutical intermediates) it may nevertheless be necessary to carry out a further purification step, for example by recrystallization with addition of small amounts of activated carbon. The yields of the reaction products are in the range from 70 to 99%; typical yields are, in particular, from 85 to 95%.

The process of the invention is illustrated by the following examples, without being restricted thereto:

### EXAMPLE 1

Preparation of 4-trifluoromethylacetophenone from 4-bromobenzotrifluoride (2 equivalents of RLi)

41.6 g of chlorocyclohexane (0.35 mol) are added dropwise to a suspension of 4.65 g of lithium granules (0.68 mol) in 350 g of THF at −55° C., with an addition time of 2 hours being selected. After a conversion of the chlorocyclohexane of >97% determined by GC (total of 10 h), 38.3 g of 4-bromobenzotrifluoride (0.170 mol) are added dropwise at the same temperature over a period of 15 minutes. After stirring for another 30 minutes at −50° C., the reaction mixture is added to 25.5 g of acetic anhydride (0.25 mol) in 50 g of THF at −30° C. (30 minutes). After stirring for another 30 minutes, the reaction mixture is poured into 120 g of water, the pH is adjusted to 6.3 by means of 37% HCl and the low boilers are distilled off at 45° C. under a slight vacuum. The organic phase is separated off and the aqueous phase is extracted twice more with 70 ml each time of toluene. Vacuum fractionation of the combined organic phases gives 29.5 g of 4-trifluoromethylacetophenone as a colorless liquid (0.157 mol, 92.2%), GC purity >98% a/a.

### EXAMPLE 2

Preparation of 4-trifluromethylacetophenone from 4-bromobenzotrifluoride (1 equivalent of RLi)

The experiment was carried out as described in example 1, but using only half the molar amount of chlorocyclohexane and lithium metal. Aqueous work-up and distillation gave 4-trifluoromethylacetophenone in a yield of only 68% in this case.

### EXAMPLE 3

Preparation of Benzoic Acid From Bromobenzene

A solution of 0.35 mol of cyclohexyllithium in THF was prepared by the method described in example 1. At −55° C., a solution of 31.4 g of bromobenzene (0.20 mol) in 50 g of THF was added dropwise over a period of 1 hour. After stirring for another 2 hours at −55° C., the resulting dark solution was added to 200 g of crushed, water-free dry ice under nitrogen. Evaporation of the unreacted CO₂ and the usual aqueous work-up gave benzoic acid in a yield of 91%.

### EXAMPLE 4

Reaction of a Chloroaromatic

Preparation of 3-trifluoromethylbenzoic acid from 3-chlorobenzotrifluoride

A solution of tert-butyllithium in THF was firstly prepared at −78° C. from 46.2 g of tert-butyl chloride (0.50 mol), 7.0 g of lithium granules, 20 mg of biphenyl and 220 g of THF (7 h). 72.2 g of 3-chlorobenzotrifluoride were subsequently added dropwise over a period of 1 hour and the mixture was stirred overnight at −78° C. and subsequently for a further 4 hours at −45° C. The reaction with CO₂ and the work-up were carried out in a manner analogous to example 3. The yield of trifluoromethylbenzoic acid in this case was 86%, HPLC purity 98.3% a/a.

### EXAMPLE 5

Preparation of 4-trifluoromethylacetophenone from 4-bromoacetophenone (2 equivalents of RLi, “one-pot variant”)

41.6 g of chlorocyclohexane (0.35 mol) are added dropwise to a suspension of 4.65 g of lithium granules (0.68 mol) in 350 g of THF at −55° C., with an addition time of 2 hours being selected. After a conversion of the chlorocyclohexane of >97% determined by GC (total of 10 h), a mixture of 38.3 g of 4-bromobenzotrifluoride (0.170 mol) and 7.0 g of acetonitrile (0.170 mol) is added dropwise at the same temperature over a period of 15 minutes. After stirring for another 30 minutes at −50° C., the reaction mixture is slowly thawed to RT and subjected to an aqueous work-up in the usual way. The yield of 4-trifluoromethylacetophenone after distillation is 81%.

1. A process for preparing aryllithium compounds comprising the steps of:
1) reacting at least one haloaliphatic compound of formula (I) with lithium metal to form a lithium alkyl of formula (II); and
2) reacting the lithium alkyl of formula (II) with at least one aromatic halogen compound of formula (III) in a halogen-metal exchange reaction to form a lithium aromatic of formula (IV), 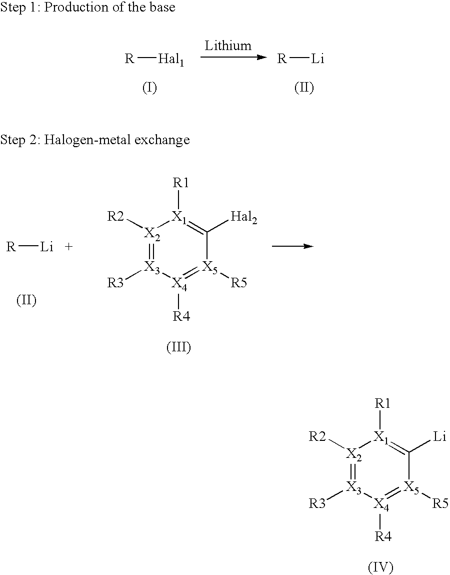
where R is methyl, a primary, secondary or tertiary alkyl radical having from 2 to 12 carbon atoms,
Hal₁=fluorine, chlorine, bromine or iodine,
Hal₂=chlorine, bromine or iodine,
X₁₋₅ are, independently of one another, each carbon or one or more moieties
X₁₋₅R₁₋₅ is nitrogen or two adjacent radicals X₁₋₅R₁₋₅ can together be O, S, NH or NR′, where R′ is C₁-C₅-alkyl, SO₂-phenyl, SO₂-p-tolyl or benzoyl;
the radicals R₁₋₅ are substituents selected from the group consisting of hydrogen, methyl, primary, secondary or tertiary, cyclic or acyclic alkyl radicals having from 2 to 12 carbon atoms.

2. The process as claimed in claim 1, wherein the process is carried out at temperatures in the range from −100 to +25° C.

3. The process as claimed in claim 1, wherein the at least one haloaliphatic compound is selected from the group consisting of chlorocyclohexane, bromocyclohexane, benzyl chloride, chlorohexanes and chloroheptanes.

4. The process as claimed in claim 1, wherein the amount of lithium to be added per mole of halogen to be reacted is in the range from 1.95 to 2.5 mol.

5. The process as claimed in claim 1, wherein the process is carried out in an ether solvent.

6. The process as claimed in claim 1, wherein organic redox systems are added in the process.

7. The process as claimed in claim 1, further comprising the step of reacting the lithium aromatic of formula (IV) with an electrophile.

8. The process as claimed in claim 7, wherein the process is carried out as a one-pot reaction and the electrophile is added to the reaction mixture at the same time as the at least one aromatic halogen compound of formula (III).

9. The process as claimed in claim 7, wherein the electrophile is a compound selected from the group consisting of carbon, boron and silicon compounds.

10. The process as claimed in claim 1, wherein, in which one or more hydrogen atoms of R₁₋₅ is replaced by fluorine, substituted cyclic or acyclic alkyl groups, alkoxy, dialkylamino, alkylamino, arylamino, diarylamino, phenyl, substituted phenyl, alkylthio, diarylphosphino, dialkylphosphino, dialkylaminocarbonyl or diarylaminocarbonyl, monoalkylaminocarbonyl, monoarylaminocarbonyl, CO₂⁻, hydroxyalkyl, alkoxyalkyl, or chlorine.

11. The process as claimed in claim 1, wherein two adjacent radicals R₁₋₄ can together correspond to an aromatic or aliphatic fused-on ring.

12. The process as claimed in claim 1, wherein R is substituted by a radical selected from the group consisting of phenyl, substituted phenyl, aryl, heteroaryl, alkoxy, dialkylamino, alkylthio}, substituted alkyl or substituted or unsubstituted cycloalkyl having from 3 to 8 carbon atoms.
